(19) United States
(12) Patent Application Publication
(10) Pub. No.: US 2015/0130651 A1
(43) Pub. Date: May 14, 2015

(54) Passive Radar Activated Anti-Collision Apparatus

(71) Applicants: Chris Mogridge, Ogden, UT (US); Alexis G. Stobbe, Oxford, MS (US)

(72) Inventors: Chris Mogridge, Ogden, UT (US); Alexis G. Stobbe, Oxford, MS (US)

(21) Appl. No.: 14/536,638

(22) Filed: Nov. 9, 2014

Related U.S. Application Data
(60) Provisional application No. 61/902,245, filed on Nov. 10, 2013.

(51) Int. Cl. H01Q 15/18

(52) U.S. Cl. CPC H01Q 15/18
USPC 342/7

(57) ABSTRACT

The apparatus of the present invention provides on-board detection systems such as automotive CAS radars the ability to react to small aspect ratio targets at an off angle to the road greatly increasing the ability of the operator of a vehicle to avoid a collision with cyclists, motorcycles, mobility devices, pedestrians and other difficult aspect ratio targets. The apparatus of the present invention is passive and can be adapted to a number of mounting schemes covering a broad spectrum of small aspect ratio targets. Examples include mounting the apparatus to the frame of a bicycle, the fender of a motorized mobility device, a motorcycle or attached to the crutch or walking stick of a pedestrian.

This non-provisional patent application claims the benefit U.S. provisional application 61/902,245, filed Nov. 10, 2013.

### BRIEF DESCRIPTION

The subject of this invention relates to detection and prevention of collisions between vehicles. Specifically, the apparatus of the present invention provides a passive radar activated apparatus that greatly enhances the return signal generated by a small target, for example, a cyclist on the side of a road, thereby warning the operator of an approaching motor vehicle of the presence of the cyclist.

### BACKGROUND OF THE INVENTION

Vehicles of many sizes make use of the roads and highways, including a range from the smallest, low-profile recumbent bicycles to the largest semi-tractor/trailer rigs. In addition, modern vehicles and roads allow for a relatively large difference in speed between the vehicles. For example, a physically impaired person operating a small aspect ratio mobility device such as a motorized wheelchair has a top speed of less than ten miles per hour, while an approaching car may be travelling at greater than fifty miles an hour. The difference in speed between the approaching car and the low visibility inherent in small aspect ratio objects sets the stage for a serious problem as a result of the rapid closing speed and the difficulty of the approaching vehicle's operator in seeing the smaller object.

Added to the increased speed issue is the fact that modernly roadways have been improved to allow expanded use such as HOV [High Occupancy Vehicle] lanes, golf cart lanes, bike lanes and so forth. Yet another improvement is the creation of a large network of dedicated “biking/hiking” paths that intersect with regular roadways and, in some cases, are part of that roadway. Each of the improvements or enhancements increases the likelihood of motor vehicles coming in very close proximity to other vehicles and/or pedestrians using the public infrastructure.

As the speed of vehicles has increased and the roads travelled by all vehicles have improved, technology has stepped in to help alleviate the problem. Many of today's modern roads have dedicated lanes for smaller slower vehicles such as bike lanes and HOV lanes. While such improvements have helped, since there is no physical barrier to prevent a collision, the inherent problem basically remains. Additionally, many roads do not have such lanes, and in fact have little or no shoulder, thus the smaller vehicle is still exposed.

Also aiding the solution to this problem has been the development of on-board automotive warning systems such as sonar, infrared and radar sensing devices, designated generally as collision avoidance systems, or CAS. One or more of these devices mounted in an approaching vehicle can serve to warn the operator of that vehicle that they are rapidly closing on a target, thus providing an opportunity to avoid a collision. Hampering these systems and devices are a number of factors including directional sensitivity, signal strength, weather conditions and level of integration.

Directional sensitivity in many of the on-board systems is such that only signals directly in front, or at a narrow viewing angle, are targeted, leaving a vehicle on the side of the road undetected. Signal strength is a problem since the radar return is predicated on the size of the target painted by the outgoing energy beam, thus a smaller vehicle, for example a cyclist or motorcycle, may not return a signal of sufficient amplitude to trigger an alarm. Weather conditions play a role since the radar energy beam may be adversely affected by droplets moving through the air in the path of the beam, depending on the beam frequency. Finally, level of integration leaves control of the vehicle in the operator's hands for the most part. While some newer systems take over control to provide rapid anti-collision response, this higher level of integration is by no means standard, thus the final decision on whether or not to apply the brakes belongs to the vehicle operator.

Added to the above is the fact that at this time only higher end vehicles are equipped with anti-collision devices capable of detecting a target. Until these devices and related control mechanisms are in place in all vehicles, the problem of detection and avoidance of smaller, difficult aspect ratio targets persists. The current trend is to equip even lower end vehicles with these CAS devices, due to mass production, related cost effectiveness factors and legislative edict. Assuming that these devices and control mechanisms will be available in most vehicles in the near future, what would be desirable would be an apparatus that allows such devices to detect and react to a small aspect ratio target such as a cyclist, a pedestrian or a disabled person in a wheelchair.

### SUMMARY OF THE INVENTION

The apparatus of the present invention provides on-board detection systems such as automotive CAS radars the ability to react to small aspect ratio targets at an off angle to the road greatly increasing the ability of the operator of a vehicle to avoid a collision with cyclists, motorcycles, mobility devices, pedestrians and other difficult aspect ratio targets. The apparatus of the present invention is passive and can be adapted to a number of mounting schemes covering a broad spectrum of small aspect ratio targets. Examples include mounting the apparatus to the frame of a bicycle, the fender of a motorized mobility device, a motorcycle or attached to the crutch or walking stick of a pedestrian.

The present invention is comprised of a corner reflector having radar reflective properties in the millimeter wavelength spectrum. Fundamentally, the apparatus is a radar reflector that returns a larger signature, or radar cross section [RCS], to the transmitting device than would otherwise have been returned in the absence of the device. In the preferred embodiment of the present invention, the corner reflector is attached directly to a bicycle or other mobility device, for example the seat stay of a bicycle frame or the fender of a mobility cart or motorcycle. An impinging radar signal from a vehicle approaching from the rear strikes the corner reflector which returns a radar signature that makes the small aspect ratio target appear to be a much larger. The enhanced RCS signal returned allows the on-board radar to react, providing a warning to the operator of the approaching vehicle an opportunity to avoid a collision.

The present invention is discussed in detail below in conjunction with the drawings listed below. As will be evident, the apparatus of the present invention overcomes the disadvantages of the prior art and provides a significant improvement in the likelihood of collision avoidance.

### BRIEF DESCRIPTION OF THE DRAWINGS

FIG. 1A: provides an overview of the problem to be solved.

FIG. 1B: provides a detailed graphical discussion of contemporary automotive radar operation.

FIG. 2A: shows the details of the preferred embodiment of the present invention.

FIG. 2B: shows the preferred embodiment of the present invention in use.

FIG. 3: provides a discussion of the present invention in operation in the presence of a second vehicle.

FIG. 4A: shows initial condition under high closure speed rate.

FIG. 4B: shows intermediate condition under high closure speed rate.

### DETAILED DESCRIPTION OF PREFERRED EMBODIMENTS

As described briefly above, the apparatus of the present invention significantly improves the likelihood of collision avoidance between a larger vehicle and a small aspect ratio target at an off angle to the vehicle. Due to the high rate of closure between a motor vehicle and a smaller object on the side of the road, for example a cyclist or a pedestrian, the distance between the vehicle and the object decreases rapidly and the attendant angle between the front of the vehicle and the object on the side of the road becomes large at a rapid rate. This increasing acquisition angle, once large enough, makes it difficult for CAS devices such as vehicle mounted radar to detect the object.

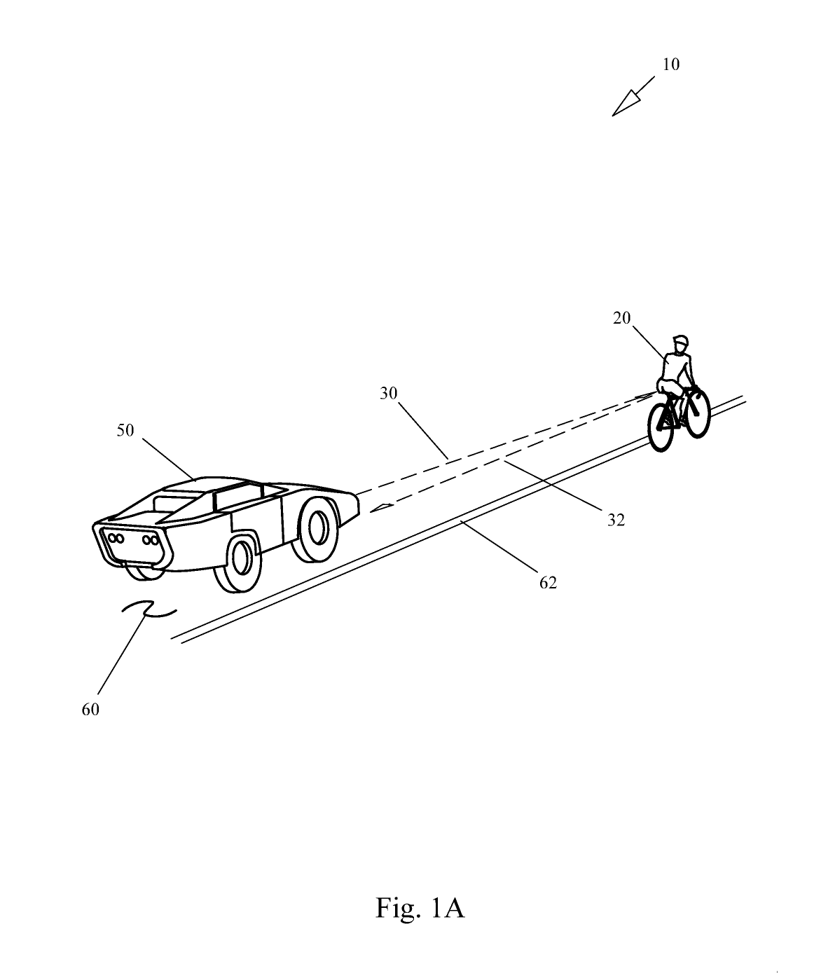

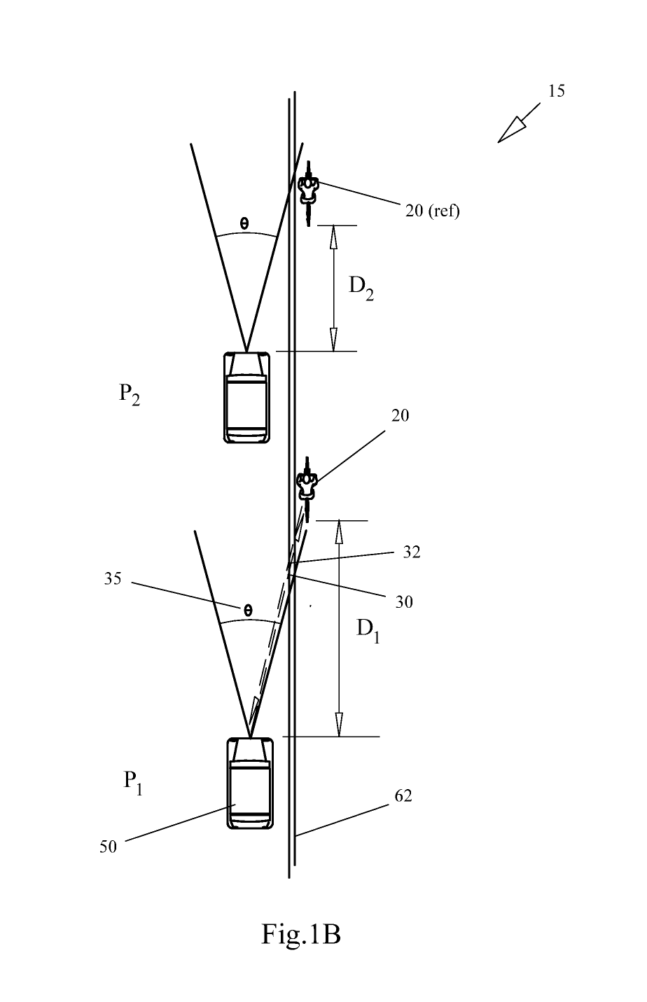

FIG. 1 provides a graphical discussion 10 of the problem to be solved. A vehicle 50 travelling on a road surface 60 is approaching a small aspect ratio target 20 from the rear. In this instance the target is a cyclist, but other small aspect ratio targets would include pedestrians, motorized mobility devices, motorized scooters, wheelchairs and others.

FIG. 1A shows a typical situation 10 where a cyclist 20 is moving in the same direction as the vehicle 50 on the shoulder of a road, separated only by lane marker 62, thus is unable to see the vehicle approaching. Supposing the vehicle 50 is of a recent vintage and has some form of collision detection capability, for example a millimeter wave radar, an outgoing signal 30 strikes the cyclist 20. A return signal 32 is sent back to the detection device. However, due to the off angle of the target and the small size—or small aspect ratio—of the target, the detection device may or may not advise the operator of the vehicle 50 that the target is present on the side of the road.

Looking now at FIG. 1B, a more detailed analysis 15 of the general situation [10 of FIG. 1A] is provided. First looking at the vehicle 50 in position P₁, a separation distance of D₁ exists between the vehicle 50 and the cyclist 20. The vehicle 50 is on the left of lane separator 62 while the cyclist 20 is on the right. Vehicle 50 is of a recent vintage and has an onboard anti-collision radar. Contemporary millimeter onboard radars have a transmit angle theta 35 of typically thirty degrees. [See for example Sabertek: Automotive Radar, http://www.sabertek.com/automotive-radar.html] At distance D1 and transmit angle theta 35 the outgoing signal 30 strikes the cyclist 20 and returns signal 32.

Turning to the vehicle 50 at position P₂, the distance between vehicle 50 and cyclist 20 has closed to D₂. Supposing the cyclist 20 is travelling at 15 mph and the vehicle 50 is travelling at 50 mph, the distance between the cyclist 20 and the vehicle 50 closes at a rate of 35 mph, or roughly fifty-one feet per second, thus in a time of only three seconds the vehicle 50 has travelled over 150 feet. In that three second time lapse the radar beam has also moved, At this distance the onboard radar no longer detects the cyclist 20 because the transmit angle theta is too narrow, leaving the cyclist 20 outside the radar beam.

The above discussion assumes that the onboard radar informed the operator of the vehicle 50 that a target was ahead. But since the cyclist 20 is a small aspect ratio target, there is no guarantee that this will be the case due to the lower RCS of the small aspect ratio target. Moreover, if the operator of the vehicle 50 did not react to the very first warning, the closing distance issue places the cyclist 20 outside the detection window of the onboard radar and thus in danger. As a result there are two problems to be solved: first, the transmit angle limitation of onboard radars and second, the strength of the signal returned to an onboard radar system.

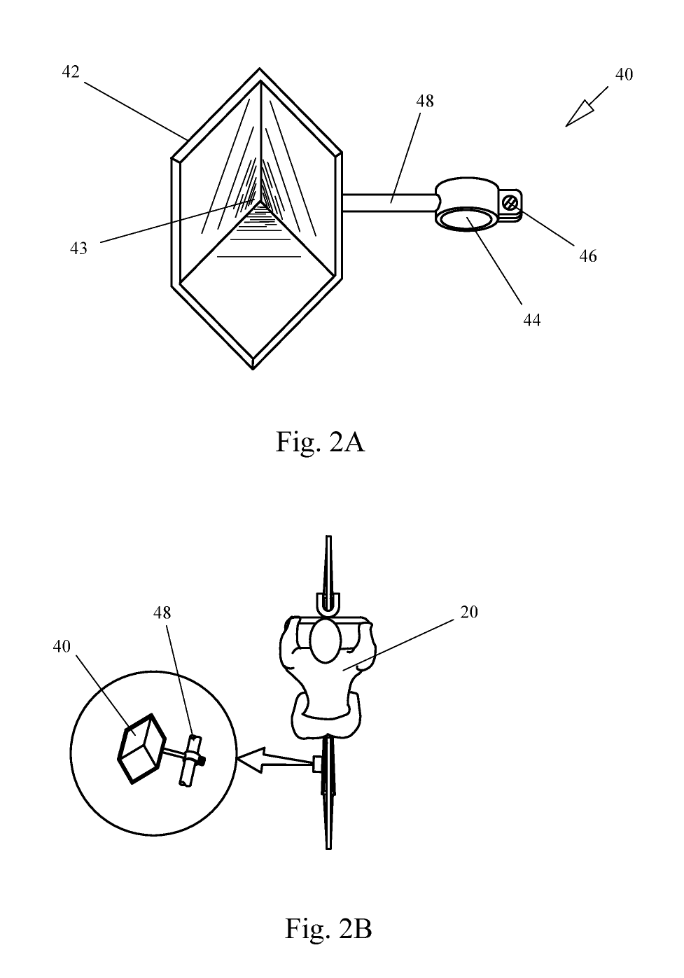

Turning now to FIG. 2, the apparatus of the present invention 40 is shown. In FIG. 2A, a corner reflector 42 is shown in detail. The apparatus of the present invention is a polyhedron, and in this instance a trihedron with each side of the trihedron 42 being 45 mm in length, 45 mm in width and 2 mm thick. In this preferred embodiment the sides of the trihedron 42 meet at a vertex forming an exterior vertex and an interior vertex. The external vertex is convex whereas the interior vertex is concave.

Trihedron 42 in a preferred embodiment is made from a highly radar reflective material such as aluminum, however, those of skill in the art will recognize that other materials could be used. By way of example, but not meant as a limitation, the trihedron 42 could be made from plastic and coated with a radar reflective coating such as a metal oxide. Also known to those of skill in the art, other polyhedrons could be used without departing from the spirit of the invention. For example, a quadrahedron or tetrahedron.

In the embodiment shown in FIG. 2A, the convex interior vertex 43 of the trihedron 42 is oriented toward the direction of an incoming radar signal from a vehicle equipped with a radar device. In the preferred embodiment depicted, the trihedron 42 has a mounting means comprised of a horizontal strut 48 and a clamp 44. The clamp 44 further has a clamp screw 46 that allows the clamp 44 to be fixably attached to a host. For the embodiment shown the apparatus of the present invention is intended for use on a bicycle seat stay, thus the clamp mechanism is dimensioned for that purpose.

The strut 48 and clamp 44 in the preferred embodiment are a single, integrated part and are made from plastic which is permanently attached to the trihedron 42 using contemporary means such as epoxy bonding. Those of skill in the art will understand that other attachment means such as threading or welding are possible without departing from the spirit of the invention. Also understood by those of skill in the art is that other host attachment means could be used, such as a flange and screw to affix the trihedron 42 to the fender of a mobility device, or hook-and-loop means to attach to a cyclist's helmet, thus the scope of the invention is limited only by the claims.

FIG. 2B provides the detail on the mounting of the preferred embodiment of the present invention on a bicycle. Rider 20 has attached the apparatus 40 of the present invention to the seat stay 60 of the bicycle. Note that the vertex of the apparatus is aligned so that it faces the rear to allow impinging radar signals from a following vehicle to enter the trihedron and be reflected back to the radar transmitter. It will be clear that although the apparatus of the present invention is shown attached to the seat stay of the bicycle, it could just as easily be attached to the seat post or the chain stay.

The important characteristic of the mounting scheme is that it aligns the vertex of the trihedron in a generally rearward direction to allow maximum exposure to the incoming radar signals from vehicles approaching from the rear. Those of skill in the art will also recognize that the apparatus of the present invention could be mounted on the front of a small aspect ratio target to allow detection from vehicles approaching from the front without departing from the spirit of the invention. In the case of a bicycle, the trihedron 42 could be mounted to the handle bars. Additionally, both a rearward and forward facing trihedrons 42 could be used at the same time to provide alert signals to vehicles approaching from both directions.

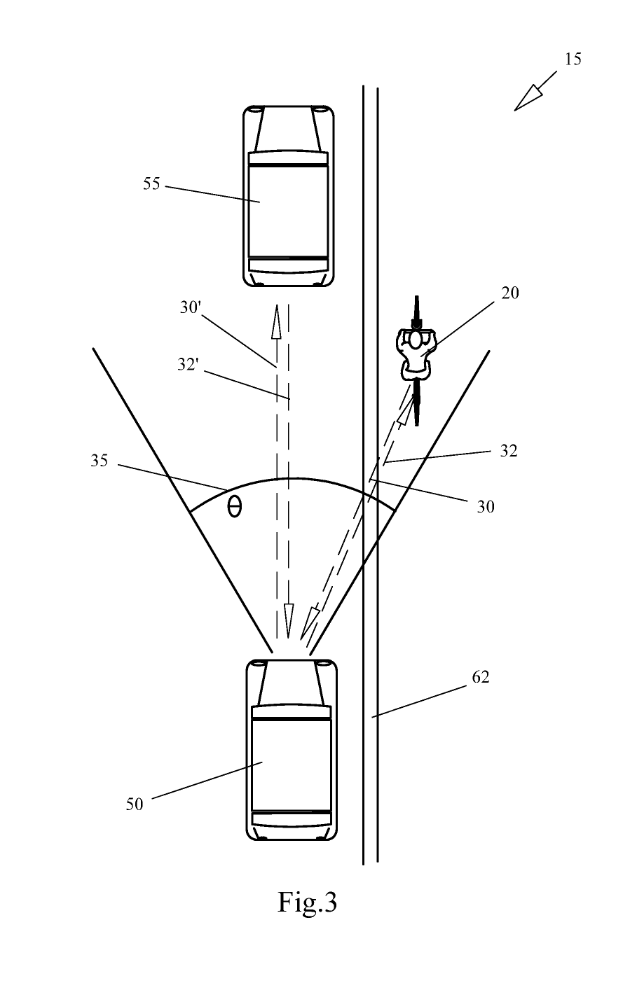

Looking at FIG. 3, an operational discussion 18 of the application of the present invention is shown in detail. A contemporary vehicle 50 is equipped with a radar device and is operating normally, emitting a radar signal across transmitting angle theta 35 which, as discussed in detail above, is thirty degrees plus or minus, or fifteen degrees to the left or right of center of the vehicle 50. A cyclist 20 is riding on the shoulder to the right of the lane separator 62, travelling in the same direction as the vehicle 50, thus is unable to see vehicle 50. Also travelling in the same direction ahead of vehicle 50 is a second vehicle 55.

The radar device of vehicle 50 is constantly transmitting and receiving signals. Outgoing signals 32 and 32′ strike their respective targets 20 and 55, returning signals 32 and 32′ in the conventional manner. As long as the second vehicle 55 is not in relatively close proximity to cyclist 20 the operator of the vehicle 50 may be advised of the presence of both the second vehicle 55 and the cyclist 20. If, however, the second vehicle 55 is beside or slightly in front of cyclist 20, the return signal from the cyclist 20 will be swamped by the strength of the signal for the second vehicle 55. This is so because the relative strength of the return signal 32′ is greater than that of return signal 32 due to the size of the second vehicle 55, specifically, the significantly greater RCS.

Suppose now that the cyclist 20 has the preferred embodiment of the present invention mounted to his/her bicycle as set out in the discussion of FIG. 2 above. When the incoming radar signal 30 impinges on the apparatus of the present invention, the reflected signal is enhanced by 10 DBsm using the 45 mm trihedron reflector described in FIG. 2A, making the cyclist 20 appear to be a substantially larger target. This increase in radar cross section will enable the onboard radar device to recognize the presence of both second vehicle 55 and cyclist 20, thereby greatly increasing the ability of the operator of vehicle 50 to avoid a collision.

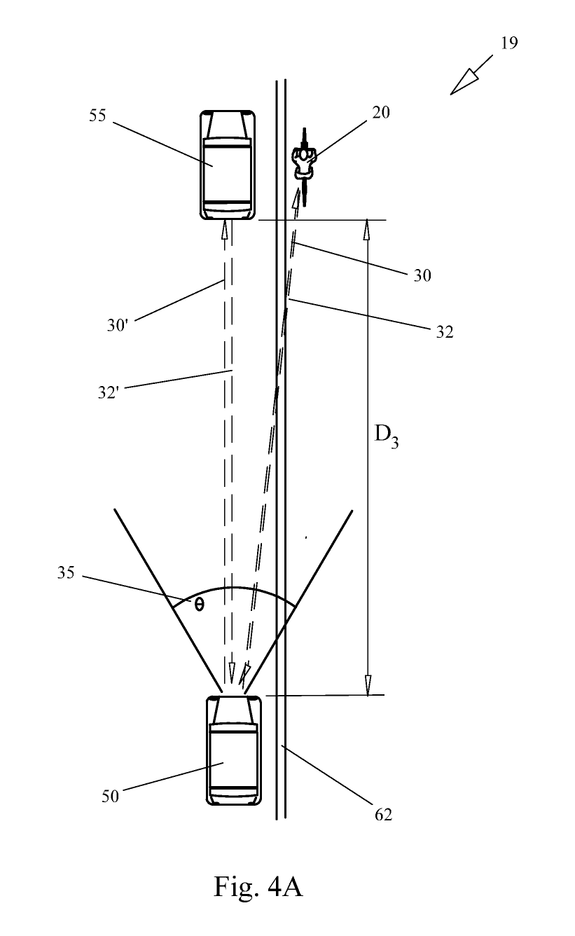

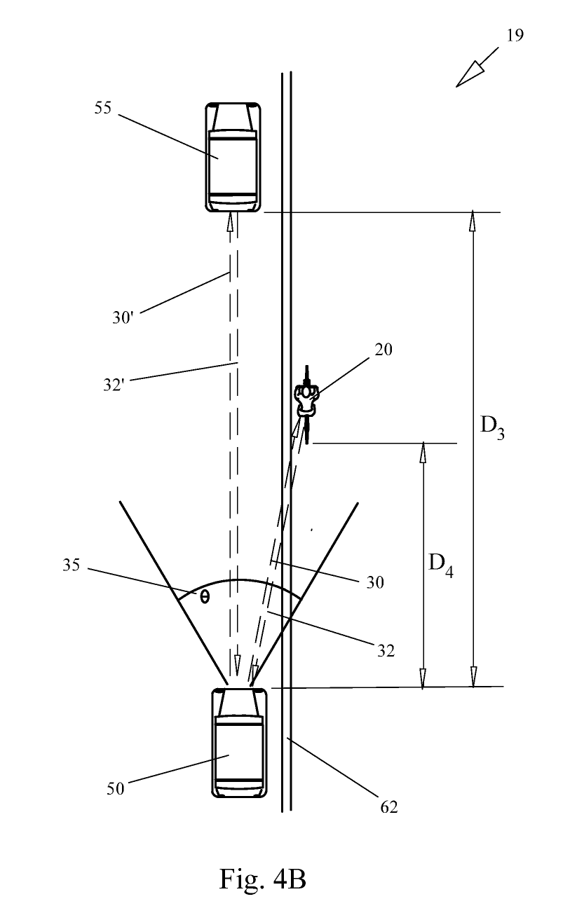

FIG. 4 presents a second operational discussion 19 that sets forth the details of the situation where there is a high closure speed between vehicle 50 and cyclist 20, including the presence of a second vehicle 55. Note that the same reference designators as those used in FIG. 1 and FIG. 3 are used here for consistency.

Looking at FIG. 4A, a cyclist 20 is travelling on the right side of the lane separator 62 at a distance D₃ from vehicle 50. Vehicle 50 has a radar device aboard with a viewing angle theta 35 of approximately 30 degrees, or 15 degrees either side of the center of the vehicle. Further up the road is a second vehicle 55 travelling in the same direction and at generally the same speed as vehicle 50, and cyclist 20 and moving at a much lower speed. Second vehicle 55 at this point in time is situated just to the left of the cyclist 20.

The radar device on board vehicle 50 transmits outgoing pulses 30 and 30′ striking cyclist 20 and second vehicle 55 respectively. Return signals 32 and 32′ from the cyclist 20 and second vehicle 55 respectively arrive at the radar device receiver at approximately the same time since they travelled effectively the same distance. Since second vehicle 55 and cyclist 20 are relatively close to each other, the return signal is strong but may appear to the operator of vehicle 50 to be a single target. At this point in time therefore, all that is known to the operator of vehicle 50 is that there is a target some distance ahead.

As will be understood, vehicles 50 and 55 are travelling a much greater speed than cyclist 20 under normal conditions. FIG. 4B describes the situation at some later point in time. At this moment the distance D₃ between vehicle 50 and second vehicle 55 remains constant since they are travelling at generally the same speed. But now there is a much smaller distance D₄ between the front of vehicle 50 and the cyclist 20. Depending on the difference in speed as discussed earlier in conjunction with FIG. 3, the time needed to create this much smaller distance may be very short, on the order of several seconds.

Two issues are presented with the situation set out in FIG. 4B. First, as the second vehicle 55 moves past cyclist 20, the return signal from second vehicle 55 remains strong while the return signal from cyclist 20 will diminish due to its smaller radar cross section. Second, as vehicle 50 continues to approach cyclist 20 the return signal will disappear since cyclist 20 will be outside the viewing angle theta 35 of the radar device.

The apparatus of the present invention significantly improves the likelihood of avoiding a collision by addressing both of these issues. For the first issue, the reduction in return signal strength, the apparatus of the present invention provides a 10 DBsm signal increase as noted earlier. Even as the distance between second vehicle 55 and cyclist 20 increases, the increased radar cross section of the corner reflector of the apparatus of the present invention [42 in FIG. 2A] ensures that the radar device ‘sees’ cyclist 20.

For the second issue, the viewing angle of the radar device, the increased return signal strength ensures that the return signal remains optimum even at the margin of the viewing angle theta 35. This ensures that the radar device does not lose track of the cyclist 20 as the viewing angle theta 35 becomes marginal. As can be seen, the apparatus of the present invention resolves both the diminished return signal issue and the viewing angle issue thereby greatly increasing collision avoidance probability.

A first advantage of the present invention is that is significantly increases the likelihood that the operator of a vehicle equipped with a collision avoidance radar device will be informed of the presence of a small aspect ratio target at an off angle to the vehicle. By increasing the level of the return signal the apparatus of the present invention appears to the transmitting device to be a larger target.

A second advantage of the present invention is that it significantly increases the ability of CAS radar devices to separate small aspect ratio targets from larger targets. This is critical in the situation where the CAS radar is responding to a second vehicle in front of the operator's vehicle but in close proximity to a small aspect ratio target at an off angle to the road. Given the high closing speed between the CAS equipped vehicle and the small aspect ratio target, the increased return signal, or radar cross section, provided by the present invention permits the operator of the vehicle to remain informed about the presence of the smaller target.

A third advantage of the present invention is that it provides an enhanced radar cross section to a CAS device as the broadcast transmit angle approaches its margin. Since the radar cross section is enhanced, the return signal to the CAS device remains strong as the margin of the transmit angle envelope is approached, keeping the operator of the vehicle appraised as to the presence of a small aspect ratio target.

A fourth advantage of the present invention is that while the preferred embodiment of the present invention has been implemented for use by cyclists, is suited for other users such as pedestrians and disabled mobility vehicles such as wheel chairs or so called scooters. By modifying the mounting means the apparatus of the present invention is easily made to attach to such areas as the fender of a mobility device or the strut of a crutch, as well as to such items as a cyclist's helmet.

A fifth advantage of the present invention is that it is economical. This is true since the apparatus of the present invention may be made from a variety of inexpensive materials such as plastic, aluminum or sheet metal. Various geometric shapes can be used in conjunction with coating materials to optimize the return signal performance.

What is claimed is:

1. An apparatus for increasing the radar cross section of a small aspect ratio target comprising:
a polyhedron having a plurality of sides, each of said sides having a length, width and thickness and wherein each of said plurality of sides meets at a single vertex thereby forming a concave interior vertex and a convex exterior vertex, and;
a mounting means fixably attached to one side of said plurality of sides of said polyhedron suitable for attachment to a host such that said concave interior vertex of said polyhedron faces in the direction of an incoming radar signal transmitted from a radar device reflecting said incoming radar signal back to said radar device at an increased signal level causing said radar device to interpret said small aspect ratio target as being of greater size.

2. An apparatus according to claim 1 wherein the polyhedron is a trihedron.

3. An apparatus according to claim 1 wherein the polygon is made from aluminum having three sides, each side of said polyhedron being 45 mm wide by 45 mm in height and having a thickness of 2 mm.

4. An apparatus according to claim 1 wherein the polygon is made from plastic having three sides, each side of said polyhedron being 45 mm wide by 45 mm in height and having a thickness of 2 mm wherein each of said sides is coated with a nickel alloy oxide.

5. An apparatus for increasing the radar cross section of a small aspect ratio target comprising:
a trihedron having a three sides, each of said sides having a length of 45 mm, a width of 45 mm and a thickness of 2 mm and wherein each of said plurality of sides meets at a single vertex thereby forming a concave interior vertex and a convex exterior vertex;
a mounting means, said mounting means further comprised of;
a horizontal strut, said horizontal strut bonded at one end to one of said sides of said trihedron, and;
a clamp at the opposite end of said strut, said clamp being an integral part of said strut, said clamp having an internal diameter suitable for attachment to a bicycle frame such that said concave interior vertex of said trihedron faces in the direction of an incoming radar signal transmitted from a radar device reflecting said incoming radar signal back to said radar device at an increased signal level causing said radar device to interpret said small aspect ratio target as being of greater size.

6. An apparatus according to claim 5 wherein the trihedron is made from aluminum having three sides, each side of said polyhedron being 45 mm wide by 45 mm in height and having a thickness of 2 mm.

7. An apparatus according to claim 5 wherein the trihedron is made from plastic having three sides, each side of said polyhedron being 45 mm wide by 45 mm in height and having a thickness of 2 mm wherein each of said sides is coated with a nickel alloy oxide.
